(19) United States
(12) Patent Application Publication
(10) Pub. No.: US 2008/0277546 A1
(43) Pub. Date: Nov. 13, 2008

(54) COUPLING SYSTEM

(76) Inventor: Peter Kahn, Brookhaven, NY (US)

Correspondence Address: ADVANTIA LAW GROUP, 9035 SOUTH 1300 EAST, SUITE 200, SANDY, UT, 84094, US

(21) Appl. No.: 12/118,636

(22) Filed: May 9, 2008

Related U.S. Application Data
(60) Provisional application No. 60/917,298, filed on May 10, 2007.

(51) Int. Cl. A47B 96/00

(52) U.S. Cl. 248/220.31

(57) ABSTRACT

A physical coupling system for power tools may comprise an extension member protruding outwardly from a base of a power tool. The extension member may include a first end and a second end flexibly coupled to a base of a power tool. The system may also include a knob coupled to the first end of the extension member, wherein the knob has a greater profile than the extension member. The system may further include a slotted cup member configured to receive and secure the knob. The extension member may further include a flexible elastic member coupled thereto and extending from the second end. The system may further comprise an elongated member having a radius smaller than that of a hole through the base of the power tool, wherein the flexible elastic member is coupled thereto at a portion that is not an end of the elongated member.

### CROSS-REFERENCE TO RELATED APPLICATIONS

This invention claims priority, under 35 U.S.C. §120, to the U.S. Provisional Patent Application No. 60/917,298 to Kahn filed on May 10, 2007, which is incorporated by reference herein.

### BACKGROUND OF THE INVENTION

1. Field of the Invention

The present invention relates to coupling system, specifically to a physical coupling system for power tools.

2. Description of the Related Art

A power tool is a tool powered by an electric motor, a compressed air motor, or a gasoline engine. Power tools are classified as either stationary or portable, where portable means handheld. They are used in industry, in construction, and around the house for cutting, shaping, drilling, sanding, painting, grinding, and polishing. Portable electric tools may be either corded or battery-powered. At present, the limitations of battery life, energy capacity, and cost keep the corded versions on the market. Compressed air is the customary power source for nailers and paint sprayers. A few tools (called powder-actuated tools) are powered by explosive cartridges. Gasoline-powered tools such as chain saws and weed whackers are made for outdoor use. Common power tools include the drill, various types of saws, the router, the electric sander, and the lathe. The term power tool is also used in a more general sense, meaning a technique for greatly simplifying a complex or difficult task.

A drill is a tool with a rotating drill bit used for drilling holes in various materials. Drills are commonly used in woodworking, metalworking, construction and DIY. The drill bit is gripped by a chuck at one end of the drill, and is pressed against the target material and rotated. The tip of the drill bit does the work of cutting into the target material, either slicing off thin shavings (twist drills or auger bits), grinding off small particles (oil drilling), or crushing and removing pieces of the work piece.

There are many types of drills; some powered manually, others using electricity or compressed air as the motive power, and a minority driven by an internal combustion engine (for example, earth drilling augers). Drills with a percussive action (such as hammer drills, jackhammers or pneumatic drills) are usually used in hard materials such as masonry (brick, concrete and stone) or rock. Some small appliances may be drill-powered, such as small pumps, grinders, etc. However, what is needed is a drill that may be easily mounted, stored, and easily accessible for use. Some improvements have been made in the field. Examples of references related to the present invention are described below, and the supported teachings of each reference are incorporated by reference herein:

U.S. Pat. No. 6,880,794, issued to Kahn, discloses a universal tool holder for carrying a tool or other article, for example, a cordless drill, nail gun, hammer or shovel is provided comprising a stretchable cord that is formed into a looped end and adapted to be wrapped about the handle of a tool in such a manner that it tightly engages the tool, and a second end having a retainable object, such as a ball, that is configured to be safely and securely held within a retaining receiver. The retaining receiver is in the form of a socket-type receiver configured to correspond to the geometrical shape of the retainable object such it can removably secure the retainable object. The socket-shaped retaining receiver can be incorporated into a variety of articles use full in carrying and storing tools, including a belt clip, a wall mounting implement or a ladder mounting implement. By integrating the retaining receiver into such a variety of articles, any tool carried by the universal tool holder can be removably secured to the retaining receiver, thereby enabling a user to suspend the tool from a belt clip, ladder or wall.

U.S. Pat. No. 6,655,560, issued to Kahn, discloses a tool accessory in the form of a cordless tool holder adaptor which is capable of being secured to a cordless tool, particularly a cordless power tool having a handle member with a lower flanged end, in order to provide the tool with means to enable it to be suspended from a holding device. In particular, the cordless tool holder adaptor is secured to the lower end of the handle of a tool, such as a cordless power drill such that the tool can be suspended from a belt clips having a swivel able hook member.

U.S. Pat. No. 6,641,011, issued to Kahn, discloses a simple and sturdy holder for hand-held tools comprising a belt clip for attachment to a user's belt, an angled hook which is retained at one end by the belt clip and a strap member for securely retaining a hand-held tool. Attachment of the strap member to the belt clip permits the thus-held tool to be carried conveniently by the workman without requiring the use of his hands. Ideally, the belt clip may be manufactured in standardized lengths to permit the use of the tool holder with belts of varying, common widths. An optional cushioning device may be used to provide padding against the body of the workman and, thereby, to improve comfort.

U.S. Pat. No. RE38,035, issued to Kahn, discloses a tool-toting device for carrying and retaining a hand tool comprising a clip, a swivel element and a U-shaped hook, the clip being capable of attachment to a belt, such as a tool belt. The swivel element is swivelably connected to the clip by conventional means, such as a semi-tubular rivet such that it freely swivels about a 360 degree axis, while the U-shaped hook is rotatably connected to the swivel element by means of a jam nut-acorn nut arrangement such that it is capable of rotating about a 360 degree axis. In this manner, a tool hanging from the U-shaped hook will swivel about the 360 degree axis, thereby maintaining its center of gravity as the user moves about a construction area. The user can re-position the hook for comfort and accessibility simply by rotating the hook about its axis.

U.S. Pat. No. 6,443,342, issued to Kahn, discloses a tool belt tool tote device that is capable of carrying two tools independently, such as a cordless drill and a hammer. The double tool tote device comprises a C-shaped clip, a terminal swivel element and two hook elements. In use, a tool depending from each hook may freely swivel to maintain its center of gravity so that the tool will remain securely attached to the tool tote while remaining easily accessible to the user. In addition, each hook element is rotatably positionable to permit the user to independently position each tool in a comfortable fashion. The two hook elements also can be selectively positioned to retain one tool element across the breadth of the two hook elements.

U.S. Pat. No. 6,062,449, issued to Kahn, discloses a tool-toting device for carrying and retaining a hand tool comprising a clip, a swivel element and a U-shaped hook, the clip being capable of attachment to a belt, such as a tool belt. The swivel element is swivelably connected to the clip by conventional means, such as a semi-tubular rivet such that it freely swivels about a 360 degree axis, while the U-shaped hook is rotatably connected to the swivel element by means of a jam nut-acorn nut arrangement such that it is capable of rotating about a 360 degree axis. In this manner, a tool hanging from the U-shaped hook will swivel about the 360 degree axis, thereby maintaining its center of gravity as the user moves about a construction area. The user can re-position the hook for comfort and accessibility simply by rotating the hook about its axis.

U.S. Pat. No. 5,743,451, issued to Kahn, discloses a tool-toting device facilitating the carrying and retention by a workman of a hand tool having a clip for attaching the device to a belt such as a workman's tool-belt. A rigid hook depends through fastening means from the clip and has the ability to swivel as the workman moves to maintain the center of gravity of a tool attached to the hook. Rigidity of the hook ensures that the workman will be able to replace the tool onto the toting device or to remove it therefrom single handedly. Further, the hook is rotatably positionable to permit the workman to position his tool in a comfortable fashion.

Problems facing tool holder designers include concerns with devices being limited in application, being expensive, being bulky, being limited in adaptability, being limited in versatility, being heavy, being flimsy, being complex, being cumbersome, and being difficult to use.

What is needed is a physical coupling system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available physical coupling systems. Accordingly, the present invention has been developed to provide a tool holder and/or a tool holding system and/or device.

A physical coupling system for power tools may comprise an extension member protruding outwardly from a base of a power tool. The extension member may include a first end and a second end flexibly coupled to a base of a power tool. The second end of the extension member may be convex. The extension member may also be flexible. In addition, the extension member may further be rigid. The system may also include a knob coupled to the first end of the extension member, wherein the knob has a greater profile than the extension member. The system may further include a slotted cup member configured to receive and secure the knob. The extension member may further include a flexible elastic member coupled thereto and extending from the second end. The flexible elastic member may extend to an interior of the base of the power tool and is secured therein under tension. The system may further comprise an elongated member having a radius smaller than that of a hole through the base of the power tool, wherein the flexible elastic member is coupled thereto at a portion that is not an end of the elongated member.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not therefore to be considered to be limiting of its scope, the invention will be described and explained with additional specificity and detail through the use of the accompanying drawing(s), in which:

FIG. 1 is a perspective view of a physical coupling system, according to one embodiment of the invention;

FIG. 2 is a perspective view of a physical coupling system, according to one embodiment of the invention;

FIG. 3 is cross sectional view of an extension member of the physical coupling system, according to one embodiment of the invention;

FIG. 4 is a bottom plan view of an extension member of the physical coupling system, according to one embodiment of the invention;

FIG. 5 is a perspective view of a physical coupling system, according to one embodiment of the invention;

FIG. 6 is a perspective view of a slotted cup member of the physical coupling system, according to one embodiment of the invention; and

FIG. 7 is a perspective view of a slotted cup member of the physical coupling system, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment or example is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

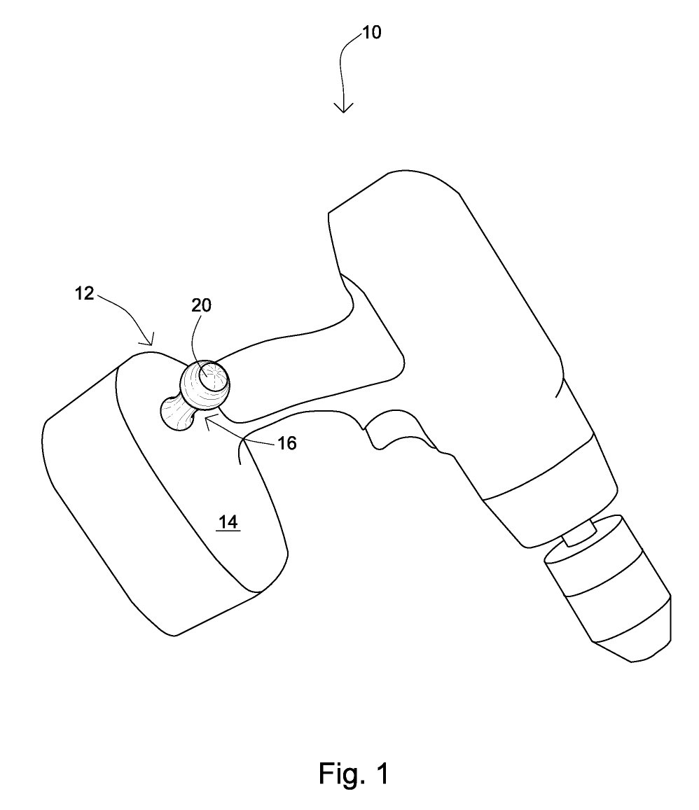

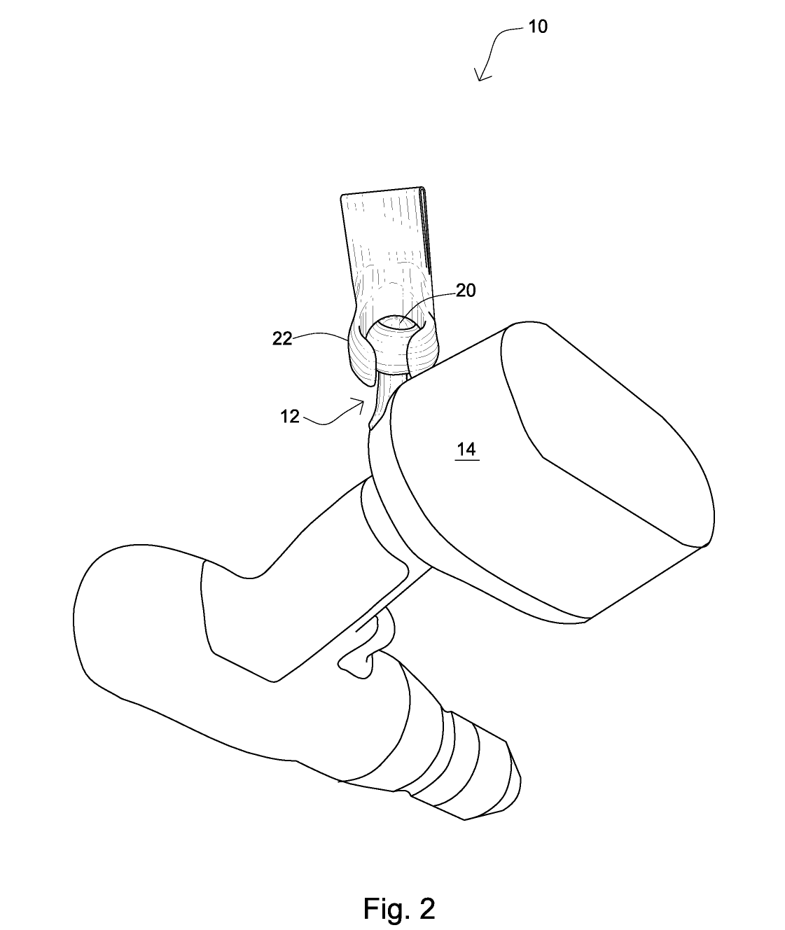

FIGS. 1 and 2 illustrate a physical coupling system 10 for power tools, according to one embodiment, wherein the system 10 includes an extension member 12 protruding outwardly from a base 14 of a power tool. The extension member 12 includes a first end 16 and a second end 18 flexibly coupled to a base 14 of a power tool. The system also includes a knob 20 coupled to the first end 16 of the extension member 12, wherein the knob 20 has a greater profile than the extension member 12. Accordingly, the knob 20 may be utilized to secure the extension member to another device as the increased profile creates a gripping portion. The knob may be spherical, polyhedral, elongated, T-shaped, irregular, and/or otherwise shaped such that the knob may present a gripping portion for attachment thereto.

This is illustrated in FIG. 2 as the system 10 further includes a slotted cup member 22 configured to receive and secure the knob 20. The extension member 12 is flexible such that the extension member is not kept at a fixed position and/or orientation. This provides several advantages in use, convenience, and safety. The illustrated flexible configuration enables the system 10 to slightly pivot when coupled to the slotted cup member 22. It is understood that the extension member may comprise flexible material and/or inflexible material. The extension member may itself flex along its length and/or may be substantially rigid so as to not bend under typical use stress. The extension member may be flexibly coupled to the base of the tool such that the extension member pivots when exposed to force.

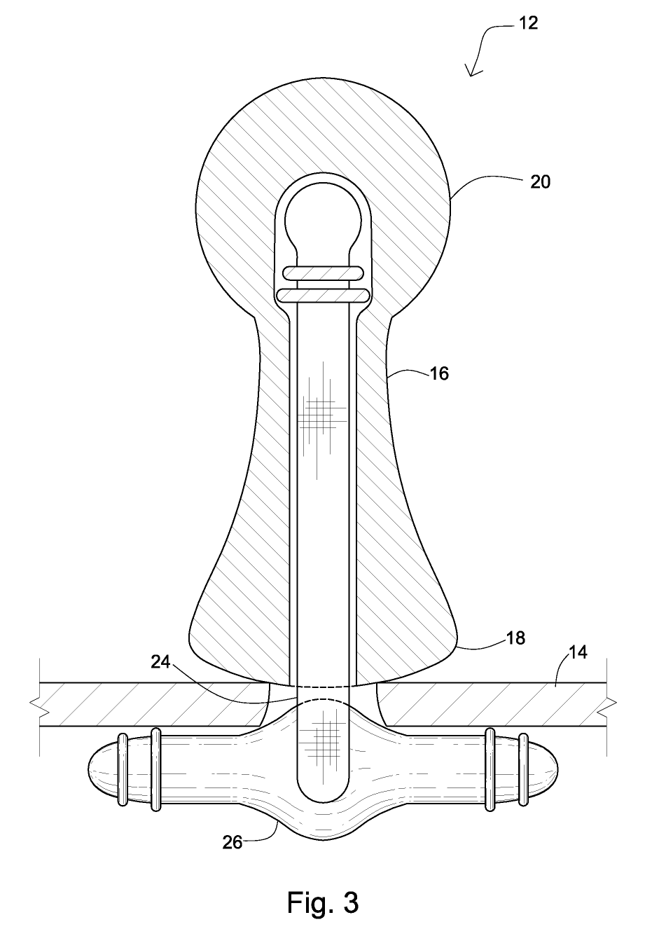

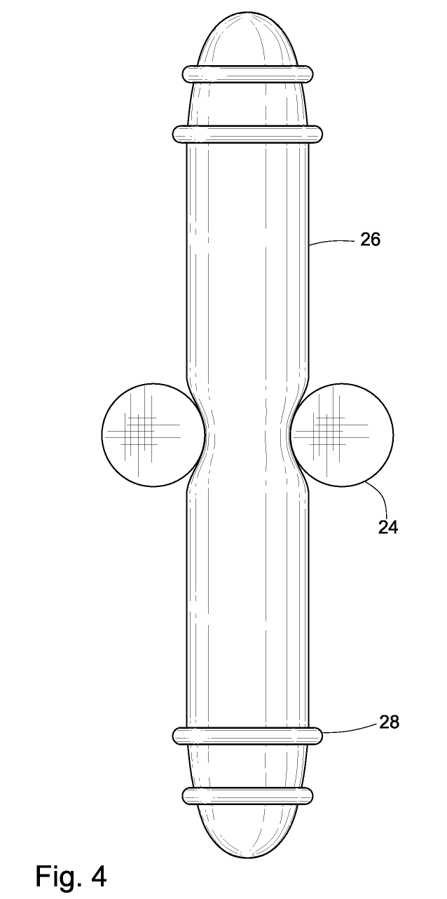

FIGS. 3 and 4 illustrate an extension member 12 of the physical coupling system 10 for power tools, according to one embodiment, wherein the extension member 12 includes a flexible elastic member 24 coupled thereto and extending from the second end 18. The flexible elastic member 24 extends to an interior of the base 14 of the power tool and is secured therein under tension. The extension member 12 further includes an elongated member 26 having a radius smaller than that of a hole through the base 14 of the power tool, wherein the flexible elastic member 24 is coupled thereto at a portion that is not an end of the elongated member. Accordingly, the elongated member may be disposed through the hole through the base of the power tool and then rotated such that the elastic member pins the elongated member in an interior of the base of the power tool.

In addition, the illustrated second end 18 of the extension member 12 is convex. Accordingly, the extension member smoothly pivots under force. Advantageously, the user is likely to be unaware of the pivoting since there is a smooth response to the force instead of a stepped or largely varied force response as may otherwise be experienced.

As illustrated in FIG. 4, the elongated member 26 includes a plurality of friction members 28 configured to secure the elongated member 26 to the interior of the base 14 of the power tool. Such may be of a material having a high coefficient of friction such as rubber. It may be that the shape and/or orientation of the friction members 28 contribute to holding the elongated member in a desired position and/or orientation.

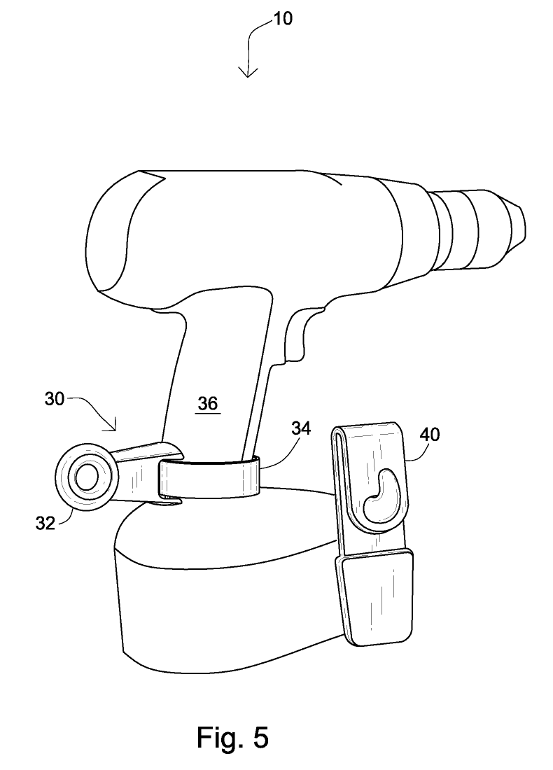

FIG. 5-7 illustrate a physical coupling system 10, according to one embodiment of the invention, wherein the system 10 includes an attachment device 30. The attachment device 30 includes an attachment member 32 coupled to a securing member 34. The securing member 34 is secured to the handle 36 of a power tool. The attachment member 32 is configured to couple to a coupling member 40, wherein the coupling member 40 is configured to secure about a belt or waist of a user.

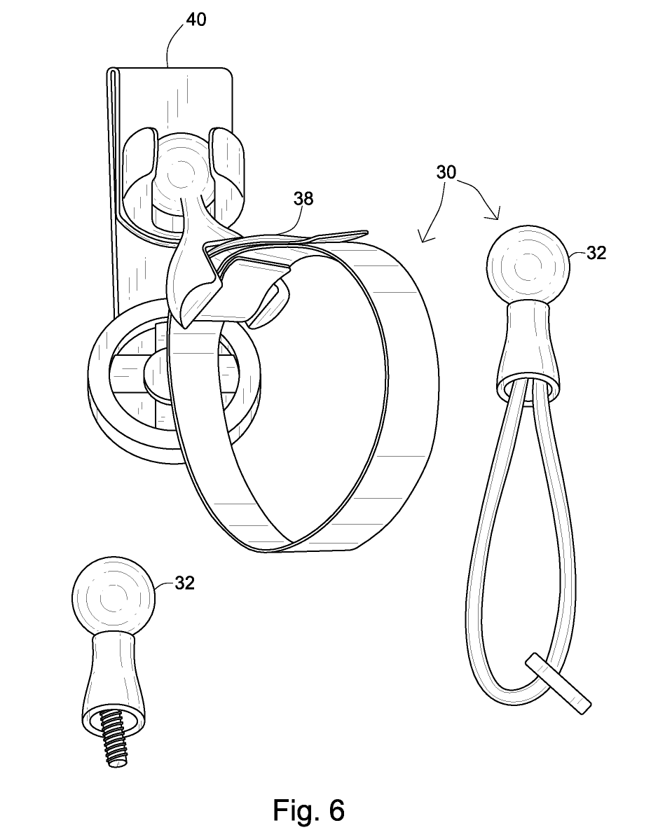

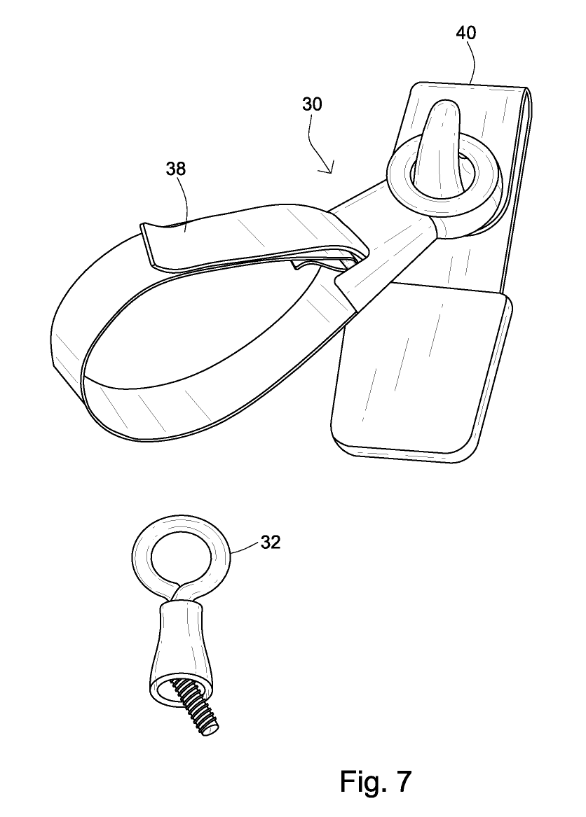

As illustrated in FIGS. 6 and 7, the securing member 34 includes an adjustment member 38, wherein the adjustment member 38 is configured to secure the securing member 34 about the handle 36 of the power tool. In addition, as further illustrated in FIGS. 6 and 7, the attachment device 20 may include a screw or bolt that may be permanently coupled to the base or handle of the power tool.

In operation of one embodiment of the invention, a tool user attaches the extension member 12 to a base 14 of a power tool. The user then couples the slotted cup member 22 about the belt or waist of the user. The user is then able to couple the knob 20 of the extension member 12 to the slotted cup member 22 thereby coupling the power tool to the hip of the user for easy manipulation and access for use.

In operation of another embodiment of the invention, the user attaches the attachment device 30 to the handle 36 of the power tool by coupling the securing member 34 about the handle 36 of the power tool. The user adjusts the adjustment member 38 to secure the securing member 34 about the handle 36 of the power tool. The user is then able to couple the attachment member 32 to the coupling member 40 to secure the power tool about the hip of the user for easy manipulation and access.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the illustrations depict a knob or loop attachment device coupled to a slotted cup member or coupling member, one skilled in the art would appreciate that the attachment and coupling members may have any combination, such as, but not limited to: a hook and ring, a ball and socket, two coupling magnets, etc. Furthermore, the invention may have a combination of various attaching and coupling members and still perform its intended function.

Additionally, although the figures illustrate a knob coupled to a power tool through a power tool base or handle, one skilled in the art would appreciate that the extension member and attachment device may be coupled to the power tool in other dispositions and still perform its intended function. For example, the attachment device may include such as, but not limited to: a securing member configured to couple about a handle of a power tool. Also, the securing member may couple about the handle of the tool and then tightens about the handle, so that the attachment member is disposed perpendicular relative to the surface of the tool handle. Further a magnet attachment mechanism may couple the tool to the attachment member and coupling member; so that one magnet couples to the tool while another magnet couples to the coupling member. The two magnets are attracted to each other, thereby coupling the power tool to a user's waist and/or belt. In addition, the attachment device may be a snap-on attachment device, wherein the attachment member snaps to the coupling member.

It is also envisioned that the attachment device may be disposed anywhere about the handle of the tool. For instance, for right-handed tool users, the attachment mechanism may be disposed on the left side of the handle when observing the tool from the posterior. The same may also be done for left handed tool users. Furthermore, the handle may be disposed at the center of the handle to allow either right and/or left handed tool users to efficiently and effectively use the device.

It is expected that there could be numerous variations of the design of this invention. For example, the extension member, attachment member, coupling member, slotted cup member, and/or frictional members may vary in size, shape, design, color, length, width, disposition and still perform their intended functions.

Finally, it is envisioned that the components of the device may be constructed of a variety of materials, such as, but not limited to plastic, metal, metal alloys, rubber, rubber compositions, magnetic metals, magnetic material, carbon fiber, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A physical coupling system for power tools, comprising:
a) an extension member protruding outwardly from a base of a power tool, including:
i) a first end; and
ii) a second end flexibly coupled to a base of a power tool; and
b) a knob coupled to the first end of the extension member, wherein the knob has a greater profile than the extension member.

2. The system of claim 1, wherein the extension member is flexible.

3. The system of claim 1, further including a slotted cup member configured to receive and secure the knob.

4. The system of claim 1, wherein the extension member is rigid.

5. The system of claim 4, wherein the extension member includes a flexible elastic member coupled thereto and extending from the second end.

6. The system of claim 5, wherein the flexible elastic member extends to an interior of the base of the power tool and is secured therein under tension.

7. The system of claim 6, further comprising an elongated member having a radius smaller than that of a hole through the base of the power tool, wherein the flexible elastic member is coupled thereto at a portion that is not an end of the elongated member.

8. The system of claim 1, wherein the second end of the extension member is convex.

9. A device for storing power tools, comprising:
a) an extension member protruding outwardly from a base of a power tool, including:
i) a first end; and
ii) a second end flexibly coupled to a base of a power tool; wherein the extension member is flexible;
b) a knob coupled to the first end of the extension member, wherein the knob has a greater profile than the extension member; and
c) a slotted cup member configured to receive and secure the knob.

10. The system of claim 9, wherein the extension member is rigid.

11. The system of claim 10, wherein the extension member includes a flexible elastic member coupled thereto and extending from the second end.

12. The system of claim 11, wherein the flexible elastic member extends to an interior of the base of the power tool and is secured therein under tension.

13. The system of claim 12, further comprising an elongated member having a radius smaller than that of a hole through the base of the power tool, wherein the flexible elastic member is coupled thereto at a portion that is not an end of the elongated member.

14. The system of claim 9, wherein the second end of the extension member is convex.

15. A device for storing power tools, comprising:
a) an extension member protruding outwardly from a base of a power tool, including:
i) a first end; and
ii) a second end flexibly coupled to a base of a power tool; wherein the extension member is flexible; wherein the extension member includes a flexible elastic member coupled thereto and extending from the second end; wherein the flexible elastic member extends to an interior of the base of the power tool and is secured therein under tension; wherein the second end of the extension member is convex;
b) a knob coupled to the first end of the extension member, wherein the knob has a greater profile than the extension member; and
c) an elongated member having a radius smaller than that of a hole through the base of the power tool, wherein the flexible elastic member is coupled thereto at a portion that is not an end of the elongated member.

16. The system of claim 15, further including a slotted cup member configured to receive and secure the knob.

17. The system of claim 15, wherein the extension member is rigid.
